(19) United States
(12) Patent Application Publication
(10) Pub. No.: US 2026/0231175 A1
(43) Pub. Date: Aug. 6, 2026

(54) DOWNLINK CONTROL INFORMATION (DCI) CO-SCHEDULING MULTIPLE CELLS AND INDICATING DEMODULATION REFERENCE SIGNAL (DMRS) ANTENNA PORTS

(71) Applicant: Apple Inc., Cupertino, CA (US)

(72) Inventors: Ankit Bhamri, Haar (DE); Chunhai Yao, Beijing (CN); Sigen Ye, San Diego, CA (US); Wei Zeng, Saratoga, CA (US); Haitong Sun, Saratoga, CA (US); Dawei Zhang, Saratoga, CA (US); Chunxuan Ye, San Diego, CA (US)

(73) Assignee: Apple Inc., Cupertino, CA (US)

(21) Appl. No.: 19/149,769

(22) PCT Filed: Feb. 10, 2023
(86) PCT No.: PCT/CN2023/075471

§ 371 Date: Jul. 21, 2025

(51) Int. Cl. H04W 72/232; H04L 27/26

(52) U.S. Cl. CPC H04W 72/232; H04L 27/261

(57) ABSTRACT

The present application relates to devices and components including apparatus, systems, and methods that support multi-cell scheduling. In an example, a base station sends a downlink control information (DCI) having a particular DCI format to a user equipment (UE). The DCI can indicate cells that are co-scheduled and can indicate a value for an index usable by the UE to determine a set of DMRS antenna port number to use for at least one cell of the co-scheduled cells. Depending on how the UE is configured for the at least one cell (e.g., depending on a configured DMRS antenna port indication table), the UE can use the value or a different value to determine the set of DMRS antenna port numbers.

### CROSS-REFERENCES TO RELATED APPLICATIONS

This application is a 371 U.S. National Phase of PCT International Patent Application No. PCT/CN2023/075471, filed Feb. 10, 2023, which is herein incorporated by reference in its entirety for all purposes.

Cellular communications can be defined in various standards to enable communications between a user equipment and a cellular network. For example, Fifth generation mobile network (5G) is a wireless standard that aims to improve upon data transmission speed, reliability, availability, and more.

### BRIEF DESCRIPTION OF THE DRAWINGS

FIG. 1 illustrates an example of a network environment, in accordance with some embodiments.

FIG. 2 illustrates an example of downlink control information (DCI) used for co-scheduling multiple cells for a user equipment (UE), in accordance with some embodiments.

FIG. 3 illustrates an example of a DCI field indicating DMRS antenna port numbers for configured cells, in accordance with some embodiments.

FIG. 4 illustrates an example of using a value in a configuration to determine a set of DMRS antenna port numbers per cell, in accordance with some embodiments.

FIG. 5 illustrates an example of possible uses of different types of DCI fields for indicating DMRS antenna port numbers, in accordance with some embodiments.

FIG. 6 illustrates an example of an operational flow/algorithmic structure for a UE to determine DMRS antenna port numbers, in accordance with some embodiments.

FIG. 7 illustrates an example of an operational flow/algorithmic structure for a base station to indicate DMRS antenna port numbers, in accordance with some embodiments.

FIG. 8 illustrates another example of an operational flow/algorithmic structure for a UE to determine DMRS antenna port numbers, in accordance with some embodiments.

FIG. 9 illustrates another example of an operational flow/algorithmic structure for a base station to indicate DMRS antenna port numbers, in accordance with some embodiments.

FIG. 10 illustrates an example of receive components, in accordance with some embodiments.

FIG. 11 illustrates an example of a UE, in accordance with some embodiments.

FIG. 12 illustrates an example of a base station, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Generally, a user equipment (UE) can be configured to communicate with a network using a multi-cell technology (also referred to herein as a multi-carrier technology). The network (e.g., a base station thereof) can co-schedule cells for downlink transmission to and/or uplink transmission from the UE. In an example, a single downlink control information (DCI) is used for the co-scheduling. The DCI can have a particular DCI format such as 1_X for a physical downlink shared channel (PDSCH) or 0_X for a physical uplink shared channel (PUSCH). The DCI format can include a DCI field that indicates common information to all the co-scheduled cells, such as a type 1A field. A value for an index is indicated by the DCI field and is used by the UE to determine a set of demodulation reference signal (DRMS) port numbers to use per co-scheduled cell.

In certain situations, the cells are configured differently for the UE. For example, relative to a second configuration for a second cell, a first configuration for a first cell has a different number of possible values for the index. To illustrate, the first configuration can be a first DMRS antenna port indication table having sixteen entries, whereas the second configuration can be a second DMRS antenna port indication table having thirty-two entries. In these and other situations, because the same value is indicated for both cells, the indicated value may not exist in the first configuration or may correspond to a reserved value for the DMRS antenna port number(s). For example, the DCI field indicates a value of twenty-four and such value does not exist in the first DMRS antenna port indication table. In such situations, the UE can instead use a default value rather than the indicated value. This default value can be the lowest value, the highest value, or some other network-configured value in the first configuration (e.g., the first entry, the last non-reserved entry, or an entry in between in the first DMRS antenna port indication table).

Further, the network may in the first place avoiding using the DCI field having the particular type (e.g., type 1A). Instead, a different type can be used, such as a type 2 field. In addition or alternatively, the UE can assume that the received DCI does not use the particular type and/or can interpret any received DCI as using a DCI field of the different type.

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or digital signal processors (DSPs) that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “base station” as used herein refers to a device with radio communication capabilities, that is a network of a communications network (or, more briefly, network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like, as used herein, refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

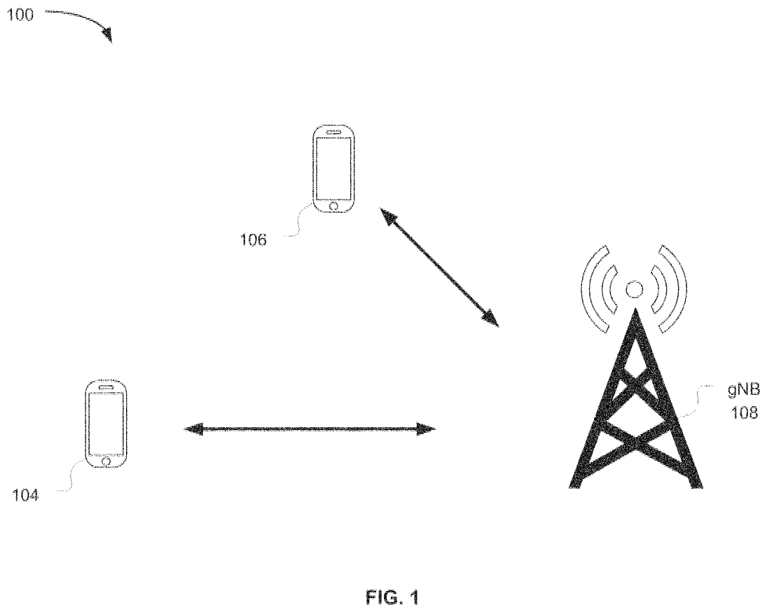

FIG. 1 illustrates a network environment 100, in accordance with some embodiments. The network environment 100 may include a UE 104 and a gNB 108. The gNB 108 may be a base station that provides a wireless access cell, for example, a Third Generation Partnership Project (3GPP) New Radio (NR) cell, through which the UE 104 may communicate with the gNB 108. The UE 104 and the gNB 108 may communicate over an air interface compatible with 3GPP technical specifications such as those that define Fifth Generation (5G) NR system standards.

The gNB 108 may transmit information (for example, data and control signaling) in the downlink direction by mapping logical channels on the transport channels, and transport channels onto physical channels. The logical channels may transfer data between a radio link control (RLC) and MAC layers; the transport channels may transfer data between the MAC and PHY layers; and the physical channels may transfer information across the air interface. The physical channels may include a physical broadcast channel (PBCH), a physical downlink control channel (PDCCH), and a physical downlink shared channel (PDSCH).

The PBCH may be used to broadcast system information that the UE 104 may use for initial access to a serving cell. The PBCH may be transmitted along with physical synchronization signals (PSS) and secondary synchronization signals (SSS) in a synchronization signal (SS)/PBCH block. The SS/PBCH blocks (SSBs) may be used by the UE 104 during a cell search procedure (including cell selection and reselection) and for beam selection.

The PDSCH may be used to transfer end-user application data, signaling radio bearer (SRB) messages, system information messages (other than, for example, MIB), and paging messages.

The PDCCH may transfer DCI that is used by a scheduler of the gNB 108 to allocate both uplink and downlink resources. The DCI may also be used to provide uplink power control commands, configure a slot format, or indicate that preemption has occurred.

The gNB 108 may also transmit various reference signals to the UE 104. The reference signals may include demodulation reference signals (DMRSs) for the PBCH, PDCCH, and PDSCH. The UE 104 may compare a received version of the DMRS with a known DMRS sequence that was transmitted to estimate an impact of the propagation channel. The UE 104 may then apply an inverse of the propagation channel during a demodulation process of a corresponding physical channel transmission.

The reference signals may also include channel status information reference signals (CSI-RS). The CSI-RS may be a multi-purpose downlink transmission that may be used for CSI reporting, beam management, connected mode mobility, radio link failure detection, beam failure detection and recovery, and fine tuning of time and frequency synchronization.

The reference signals and information from the physical channels may be mapped to resources of a resource grid. There is one resource grid for a given antenna port, subcarrier spacing configuration, and transmission direction (for example, downlink or uplink). The basic unit of an NR downlink resource grid may be a resource element, which may be defined by one subcarrier in the frequency domain and one orthogonal frequency division multiplexing (OFDM) symbol in the time domain. Twelve consecutive subcarriers in the frequency domain may compose a physical resource block (PRB). A resource element group (REG) may include one PRB in the frequency domain and one OFDM symbol in the time domain, for example, twelve resource elements. A control channel element (CCE) may represent a group of resources used to transmit PDCCH. One CCE may be mapped to a number of REGs, for example, six REGs.

The UE 104 may transmit data and control information to the gNB 108 using physical uplink channels. Different types of physical uplink channels are possible including, for instance, a physical uplink control channel (PUCCH) and a physical uplink shared channel (PUSCH). Whereas the PUCCH carries control information from the UE 104 to the gNB 108, such as uplink control information (UCI), the PUSCH carries data traffic (e.g., end-user application data) and can carry UCI.

The UE 104 and the gNB 108 may perform beam management operations to identify and maintain desired beams for transmission in the uplink and downlink directions. The beam management may be applied to both PDSCH and PDCCH in the downlink direction, and PUSCH and PUCCH in the uplink direction.

In an example, communications with the gNB 108 and/or the base station can use channels in the frequency range 1 (FR1) band, frequency range 2 (FR2) band, and/or high frequency range (FRH) band. The FR1 band includes a licensed band and an unlicensed band. The NR unlicensed band (NR-U) includes a frequency spectrum that is shared with other types of radio access technologies (RATs) (e.g., LTE-LAA, WiFi, etc.). A listen-before-talk (LBT) procedure can be used to avoid or minimize collision between the different RATs in the NR-U, whereby a device should apply a clear channel assessment (CCA) check before using the channel.

As further illustrated in FIG. 1, the network environment 100 may further include a base station 112 with which the UE 104 may also connect. The base station 112 supports the same RAT as the gNB 108 (e.g., the base station 112 is also a gNB). Additionally or alternatively, the base station 112 supports a different RAT (e.g., Long-Term Evolution (LTE) eNB).

In an example, the UE 104 supports carrier aggregation (CA), whereby the UE 104 can connect and exchange data simultaneously over multiple component carriers (CCs) with the gNB 108 and/or the base station 112. The CCs can belong to the same frequency band, in which case they are referred to as intra-band CCs. Intra-band CCs can be contiguous or non-contiguous. The CCs can also belong to different frequency bands, in which case they are referred to as inter-band CCs. A serving cell can be configured for the UE 104 to use a CC. A serving cell can be a primary (PCell), a primary secondary cell (PSCell), or a secondary cell (SCell). Multiple SCells can be activated via an SCell activation procedures where the component carriers of these serving cells can be intra-band contiguous, intra-band noon-contiguous, or inter-band. The serving cells can be collocated or non-collocated.

The UE 104 can also support dual connectivity (DC), where it can simultaneously transmit and receive data on multiple CCs from two serving nodes or cell groups (a master node (MN) and a secondary node (SN)). DC capability can be used with two serving nodes operating in the same RAT or in different RATs (e.g., an MN operating in NR, while an SN operates in LTE). These different DC modes include, for instance, evolved-universal terrestrial radio access-new radio (EN)-DC, NR-DC, and NE-DC (the MN is a NR gNB and the SN is an LTE eNB).

A single DCI can be used to co-schedule different cells for downlink transmission to the UE 104 (e.g., on PDSCH). This DCI can be referred to as DCI format 1_X. Similarly, a single DCI can be used to co-schedule different cells for uplink transmission from the UE 104 (e.g., on PUSCH). This DCI can be referred to as DCI format 0_X. The use of such DCI is further illustrated in the next figures.

As further illustrated in FIG. 1, the network environment 100 may include additional UEs, such as UE 106 in communication with the gNB 108. Although not shown, the network environment 100 may also include multiple base stations that may be communicatively coupled with the gNB 108 and/or with the UE 104 and/or 106.

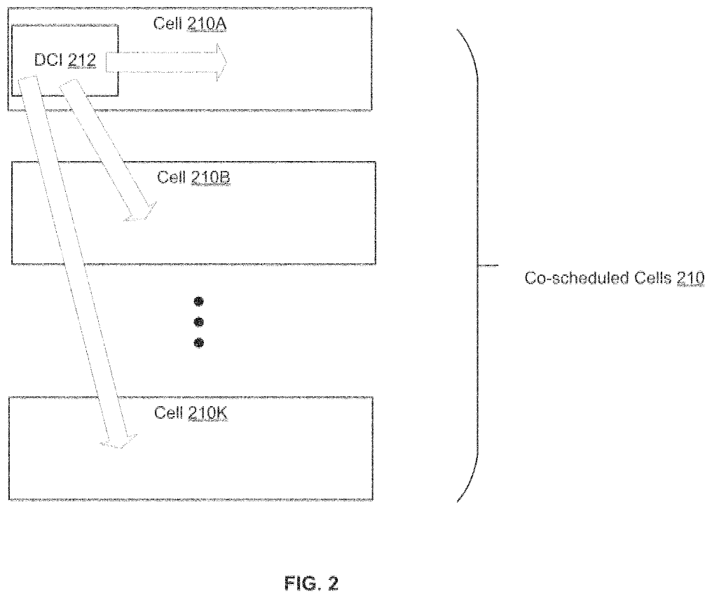

FIG. 2 illustrates an example of DCI 212 used for co-scheduling multiple cells 210 for a UE, in accordance with some embodiments. The DCI 212 can be DCI format 1_X or DCI format 0_X. As illustrated, the number of co-scheduled cells 210 by the same, single DCI 212 is “K.” For example, “K” can be two, three, or four, although a larger positive integer can be possible. The DCI 212 is sent in one cell 210A (e.g., using a first CC) and can co-schedule this cell 210A (or possibly not), cell 210B (that uses a second CC), and so on up to cell 210K (that uses a K^{th} CC).

Generally, the DCI 212 schedules more than one cell and includes different fields for the scheduling. Among these fields, a field can indicate a value for an index to be used by the UE for determining a set of DMRS antenna ports numbers. This field, referred to herein as a DMRS antenna port indication field for ease of reference can be common to all co-scheduled cells 210 (e.g., the same value is indicated for the DMRS antenna port number per cell) or separate for each one of the co-scheduled cells 210.

In the use case of DCI format 0_X or 1_X, the DCI that schedules more than one cell can include a type-1 field, a type-2 field, or a type-3 field. For a type-1 field, multiple possibilities may exist. A type-1A field can be used as a single field indicating common information to all the co-scheduled cells. A type-1B field can be used as a single field indicating separate information to each of co-scheduled cells via joint indication. A type-1C field can be used as single field indicating information to only one of co-scheduled cells. In comparison, a type-2 field can be used as separate field for each of the co-scheduled cells. A type-3 field can be used as a common field or a separate field to each of the co-scheduled cells, or separate to each sub-group, dependent on explicit configuration (e.g., a configuration via RRC).

For DCI format 1_X, the DMRS antenna port indication field can be configurable between type 1A and type 2. This can also be the case for DCI format 0_X. Nonetheless, other field types may be possible.

Specific to a type 1A field, this field can be of a certain size (e.g., four, five, or six bits) bits based on maximum size of this field in legacy formats across cells in the set configured for the DCI format 1_X (or DCI format 0_X). Referring to FIG. 2, assume that the DCI 212 co-schedules cells 210A and 210B. Also assume that a four-bit configuration is used for the cell 210A, whereas a five-bit configuration is used for the cell 210B. Here, the bit configuration for a cell can be the number of bits used to indicate a value of an index usable by the UE to look up the set of DMRS antenna port numbers for use for the cell, as further described in the next figures. In such case, the type 1A field used in the DCI 212 to co-schedule cells 210A and 210B is set to have a size of five bits. For each of the co-scheduled cells, the indicated bits (e.g., the index value) is interpreted independently as in legacy formats. For example, the same five bits are interpreted by the UE twice: the first time in a look-up of a first configuration (e.g., a first DMRS table) for the cell 210A, and the second time (e.g., separately from the first time) in a look-up of a second configuration (e.g., a second DMRS table) for the cell 210B. To which cells the type 1A field applies can be determined from another field in the DCI 212, where this other field can indicate the co-scheduled cells.

Specific to a type 2 field, the field size is the sum of bits for each cell in the set configured for the DCI format 1_X (e.g., the sum of four, five, six, etc. depending on the configured cells that are also co-scheduled). The indicated bits for each cell is interpreted as legacy formats for the cell independently of the indicate bits for the other cell(s). The field size can be reduced with a legacy configuration.

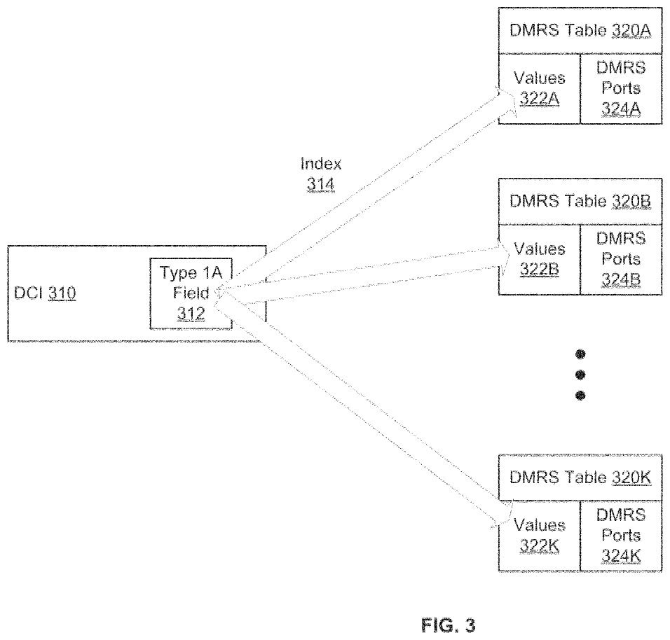

FIG. 3 illustrates an example of a DCI field indicating DMRS antenna port numbers for configured cells, in accordance with some embodiments. Here, a single DCI 310 is used to schedule multiple cells. The DCI 310 can have a format 0_X or 1_X. The DCI 310 can indicate the scheduled cells (e.g., by including their respective cell identifiers or indicators of such identifiers). The DCI 310 can also include a DMRS antenna port indication field. In the illustration of FIG. 3, the DMRS antenna port indication field is configured as a type 1A field 312. The type 1A field 312 can include a plurality of bits forming a bitmap. The value of the bitmap corresponds to an index that is used by the UE separately to determine the set of DMRS antenna port numbers to use per co-scheduled cell.

In particular, multiple cells can be configured for the UE. A first configuration can correspond to a first cell (e.g., the cell 210A of FIG. 2), a second configuration can correspond to a second cell (e.g., the cell 210B of FIG. 2), and so on until a K^{th} configuration corresponding to a K^{th} cell (e.g., the cell 210K of FIG. 2). It may be possible to use the DCI 310 to co-schedule all or a subset of the “K” cells. The configuration for each cell can include information usable to determine the set of DMRS antenna port numbers to use. An example of such information for a cell is a DMRS antenna port indication table (referred to herein as a DMRS table in the interest of brevity). Generally, a DMRS table (or, more broadly, a configuration for a cell) can include multiple index value entries and DMRS antenna port entries. An index value entry can indicate a value of an index and can be associated with a DMRS antenna port entry. The associated DMRS antenna port entry can indicate the set of DMRS antenna port number(s) to use. An example of a DMRS table can be any one of the tables showing DMRS antenna port numbers in section 7.3.1.1.2 or 7.3.1.2.2 of 3GPP TS 38.212 V17.4.0 (2023-01), which is incorporated herein by reference in its entirety, or any other technical specifications describing the same, similar, or equivalent tables.

In the illustration of FIG. 3, a DMRS table 320A is part of the first configuration of the first cell, a DMRS table 320B is part of the second configuration of the second cell, and so on until a DMRS table 320K that is part of the K^{th} configuration of the K^{th} first cell. Each of these DMRS tables includes values that the index can take (e.g., the DMRS table 320A includes values 322A, the DMRS table 320B includes values 322B, and the DMRS table 320K includes values 322K). Each value in each DMRS table is associated with a set of DMRS antenna port numbers (e.g., each one of the values 322A is associated with one of the DMRS antenna port entries 324a, each one of the values 322B is associated with one of the DMRS antenna port entries 324B, and each one of the values 322K is associated with one of the DMRS antenna port entries 324K). The sizes of the DMRS tables 320A-K can be different. For example, the DMRS table 320A can include a larger or smaller number of entries (or rows) than the DMRS table 320B. To illustrate, the DMRS table 320A can include sixteen possible values 322A and sixteen associated sets of DMRS antenna port numbers 324A. This can be the case when, for example, for DMRS type 1 and max length of 1 is configured for the first cell (see e.g., Table 7.3.1.2.2-1 of 3GPP TS 38.212 V17.4.0 (2023-01)). In comparison, the DMRS table 320B can include thirty-two possible values 322A and thirty-two associated sets of DMRS antenna port numbers 324A (see e.g., Table 7.3.1.2.2-2 of 3GPP TS 38.212 V17.4.0 (2023-01)). This can be the case when, for example, for DMRS type 1 and max length of 2 is configured for the second cell.

Assuming that all K cells are co-scheduled by the DCI 310, the type 1A field 312 indicates a single value for the index use by the UE to independently determine the set of DMRS antenna port numbers to use for each of the co-scheduled cells. For example, the UE uses the value in a first look-up of the first DMRS table 320A to determine a first value from the values 322A and then determine the associated set of DMRS antenna port numbers from the DMRS antenna port entries 324A. Similarly, the UE uses that same value in a second look-up of the second DMRS table 320B to determine a second value from the values 322B and then determine the associated set of DMRS antenna port numbers from the DMRS antenna port entries 324B. This type of look-up is repeated for the remaining co-scheduled cell(s). These two example tables are copied below. The first column in each table corresponds to the illustrated values 322A or 322B. The last column in Table 1 corresponds to the illustrated DMRS antenna port numbers 324A. The third and seventh column in Table 2 correspond to the DMRS antenna port numbers 324B.

TABLE 1
(example of DMRS table 320A)
One Codeword:
Codeword 0 enabled,
Codeword 1 disabled

| | Number of DMRS | |
|---|---|---|
| | CDM group(s) | DMRS |
| Value | without data | port(s) |
| 0 | 1 | 0 |
| 1 | 1 | 1 |
| 2 | 1 | 0, 1 |
| 3 | 2 | 0 |
| 4 | 2 | 1 |
| 5 | 2 | 2 |
| 6 | 2 | 3 |
| 7 | 2 | 0, 1 |
| 8 | 2 | 2, 3 |
| 9 | 2 | 0-2 |
| 10 | 2 | 0-3 |
| 11 | 2 | 0, 2 |
| 12-15 | Reserved | Reserved |

TABLE 2
(example of DMRS table 320B)

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number | | | | Number | | |
| | of | | | | of | | |
| | DMRS | | | | DMRS | | Number |
| | CDM | | Number | | CDM | | of |
| | group(s) | | of front- | | group(s) | | front- |
| | without | DMRS | load | | without | DMRS | load |
| Value | data | port(s) | symbols | Value | data | port(s) | symbols |
| 0 | 1 | 0 | 1 | 0 | 2 | 0-4 | 2 |
| 1 | 1 | 1 | 1 | 1 | 2 | 0, 1, 2, 3, 4, 6 | 2 |
| 2 | 1 | 0, 1 | 1 | 2 | 2 | 0, 1, 2, 3, 4, 5, 6 | 2 |
| 3 | 2 | 0 | 1 | 3 | 2 | 0, 1, 2, 3, 4, 5, 6, 7 | 2 |
| 4 | 2 | 1 | 1 | 4-31 | reserved | reserved | reserved |
| 5 | 2 | 2 | 1 | | | | |
| 6 | 2 | 3 | 1 | | | | |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 0 | 2 | | | | |
| 13 | 2 | 1 | 2 | | | | |
| 14 | 2 | 2 | 2 | | | | |
| 15 | 2 | 3 | 2 | | | | |
| 16 | 2 | 4 | 2 | | | | |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | Reserved | Reserved | Reserved | | | | |

In certain situations, the value indicated by the type 1A field 312 in the DCI 310 can correspond to a reserved value in a cell configuration (e.g., in a DMRS table) or can be non-existent in the cell configuration. For example, consider the example where the DMRS table 320A includes sixteen possible values 322A and sixteen associated sets of DMRS antenna port numbers 324A. In this example, the DMRS table 320B includes thirty-two possible values 322A and thirty-two associated sets of DMRS antenna port numbers 324A. The indicated value can be fifteen and can correspond to a reserved value for the DMRS port numbers in the DMRS table 320A, and to a usable set of DMRS port numbers in the DMRS table 320B. As such, for the first cell, the indicated value cannot be used to determine the DMRS port numbers to use for the first cell (whereas this determination is possible for the second cell). Similarly, the indicated value can be twenty (or some value larger than fifteen and smaller than thirty-one). In this case also, the indicated value cannot be used to determine the DMRS port numbers to use for the first cell (whereas this determination is possible for the second cell).

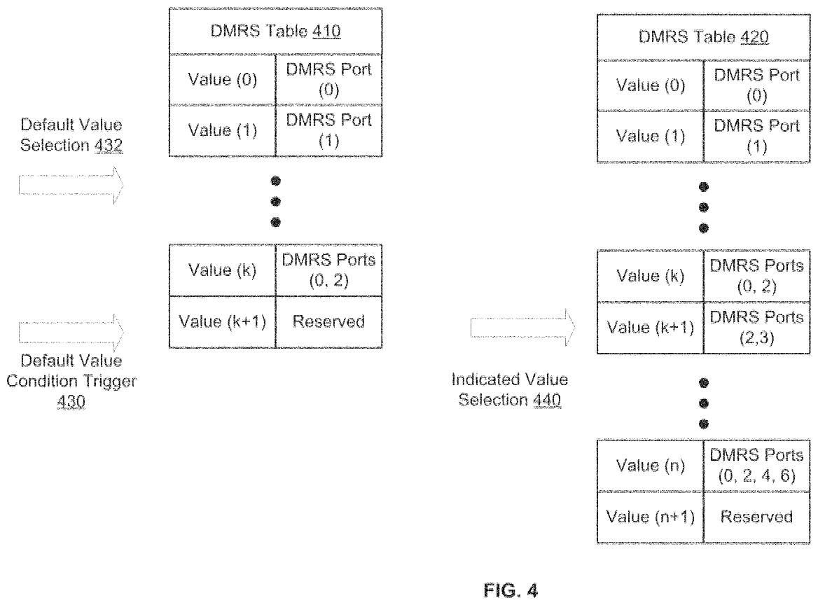

FIG. 4 illustrates an example of using a value in a configuration to determine a set of DMRS port numbers per cell, in accordance with some embodiments. Here, a DCI field in a DCI (e.g., the type 1A field 312A of FIG. 3) indicates the value. In the illustration, two configured cells (e.g., cells 210A and 210B of FIG. 2) are co-scheduled. The UE has a first configured for the first cell, where the first configuration includes a first DMRS table 410 (e.g., the DMRS table 320A of FIG. 3). Similarly, the UE has a second configured for the second cell, where the second configuration includes a second DMRS table 420 (e.g., the DMRS table 320B of FIG. 3).

The UE determines the value indicated in the DCI field and uses this indicated value in different lookups of the two configurations. The UE also determines a condition 430 to trigger the use of a default value (e.g., a second value) for at least the first cell instead of the indicated value (e.g., a first value). The condition includes at least one of the indicated value corresponding to a reserved value in the first configuration for the first cell or a number of possible values in the first configuration is different than that in a second configuration for the second cell. Referring to the DMRS table 410 and 420 as example configuration information in the two configurations, the condition can be understood to be: if the size of the DMRS antenna port indication table for at least one of the co-scheduled cells is different than the size of the DMRS antenna port indication tables for the other co-scheduled cells, and/or if the indicated index is reserved in the DMRS antenna port indication table for at least one of the co-scheduled cells, then the default value is to be used, then for the at least one co-scheduled cells, the lowest index, the highest index (not the reserved index), or an index configured in between is used from the corresponding DMRS antenna port indication table to determine the DMRS antenna port number(s).

To illustrate, consider the example Table 1 and Table 2 above. If the indicated value is fifteen, that value is not usable for the first cell (e.g., the condition “if the indicated index is reserved in the DMRS antenna port indication table for at least one of the co-scheduled cells” is met). In this case, the indicated value can be usable for the second cell. Likewise, if the indicated value is twenty, that value is not usable for the first cell (e.g., this value is excluded from the first Table because the sub-condition “if the size of the DMRS antenna port indication table for at least one of the co-scheduled cells is different than the size of the DMRS antenna port indication tables for the other co-scheduled cells” is met). Any of these two sub-conditions can be met because the bitmap used in the type 1A field is set according to the maximum size across the co-scheduled cells.

Continuing with the example of two cells, for the first cell, the UE can perform a selection 432 of the default value. The default value can be the lowest value in the DMRS table 420 (e.g., the lowest index “0” per Table 1) in which case the UE can determine an associated DMRS antenna port set (e.g., DMRS port “0” per Table 1). The default value can be the highest value in the DMRS table 420 for which no reserved value exists for the DMRS antenna port set (e.g., the highest index “11” per Table 1) in which case the UE can determine an associated DMRS antenna port set (e.g., DMRS ports “0,2” per Table 1). Alternatively, the default value can be configured by the network (e.g., the base station) for the UE (e.g., via RRC signaling) to be in between the lowest value and the highest value (e.g., index “8” per Table 1). This configuration can be specific to the first cell or can be common to all configured cells. Because the indicated value can be usable for the second cell, the UE does not need to perform the selection 432 of a default value. Instead, the UE select 440 the indicated value and uses it to determine the DMRS antenna port set. Referring back to Table 2, the UE determines that for index “15,” the DMRS antenna port set is DMRS antenna port “2” in the case of codeword “1.”

In certain situations, a DMRS table configured for a cell can include entries for a multi-symbol DMRS. In the example of Table 2, codeword “1” being disabled corresponds to a 1-symbol length DMRS. In comparison, codeword “1” being enabled corresponds to a 2-symbol length DMRS. In these situations, a third sub-condition can be introduced to trigger the selection 432 of a default value instead of the indicated value. In particular, if the size of the DMRS antenna port indication table for at least one of the co-scheduled cells is different than the size of the DMRS antenna port indication tables for the other co-scheduled cells, and/or if the indicated index is reserved in the DMRS antenna port indication table for at least one of the co-scheduled cells, and/or if the DMRS antenna port indication table configured for the at least one of the co-scheduled cell is for multi-symbol length DMRS (e.g., a 2-symbol DMRS), then, for the at least one co-scheduled cells, lowest index, a highest index (for which no reserved value is set for the DMRS antenna port set), or an index configured in between for multi-symbol length DMRS is used from the corresponding DMRS antenna port indication table to determine the DMRS antenna port number(s).

To illustrate this condition, reference is made back to Table 2 and the indicated value of fifteen. In this example, the codeword “1” is enabled. As such, the indicated value corresponds to a reserved value for the DMRS antenna port set and is not usable for the second cell. Therefore, the UE can perform the selection 432 of a default value, by selecting index “0” (resulting in selecting DMRS ports “0-4,”), index “3” (resulting in selecting DMRS ports “0,1,2,3,4,5,6,7”) or an index between “0” and “3.”

Continuing with the example of FIG. 4, the network (e.g., a base station) can schedule cells for different UEs (e.g., the UE 104 and the UE 106 of FIG. 1). When the condition is met for a first UE (e.g., the UE 104), the network can assume that the first UE will use a default value instead of the indicated value and, thus, will use a particular set of DMRS antenna ports that depend on the default value. The network can determine that the condition is met given that the network configures the cells for the UE and, subsequently co-schedules particular ones by using a single DCI. In this case, the network can indicate a value in the DCI for first UE 104 to use, with the assumption that the UE would use a default value instead for at least a first cell of a plurality of co-scheduled cells. The network can also indicate that same value in a different DCI for the second UE (e.g., the UE 106) that schedules transmission of the second UE in the first cell too. That is possible because the second UE would not determine the same DMRS antenna port number(s) as the first UE given that the first UE would not use the indicated value (e.g., would use a default value) and that the second UE would use the indicated value (or, if the condition is also met for the second UE, would use a different default value).

As such, when the condition is met for at least a first UE and a first a cell among a plurality of cells co-scheduled for the at least first UE, the network can use the same index (e.g., one having the same value) in a first DCI sent to the first UE and a second DCI sent to a second UE. The indicated value of the index is used by the first UE to determine a first set of DMRS antenna port numbers to use for the first cell. This use includes selecting a default value instead of the indicated value. The indicated value of the index is also used by the second UE to determine a second set of DMRS antenna port number to use for the first cell. The first set and the second set are different. This use includes using the indicated value to determine the second set (e.g., in the case where the network schedules only the first cell for the second UE or in the case where the network co-schedules multiple cells for the second UE but the condition is not met). This use includes using a different default value to determine the second set (e.g., in the case where the network co-schedules multiple cells for the second UE and the condition is also met for the first cell and the second UE). In this latter case, the network can configure the two UEs to use different default values (e.g., the first UE is configured to use the lowest index, whereas the second UE is configured to use the largest index).

The example of FIG. 4 is provided for illustrative purposes only. Other DMRS tables can be used. Similarly, more than two cells can be co-scheduled. In this case, the selection 432 of a default value for each cell can depend on how the condition 430 is met.

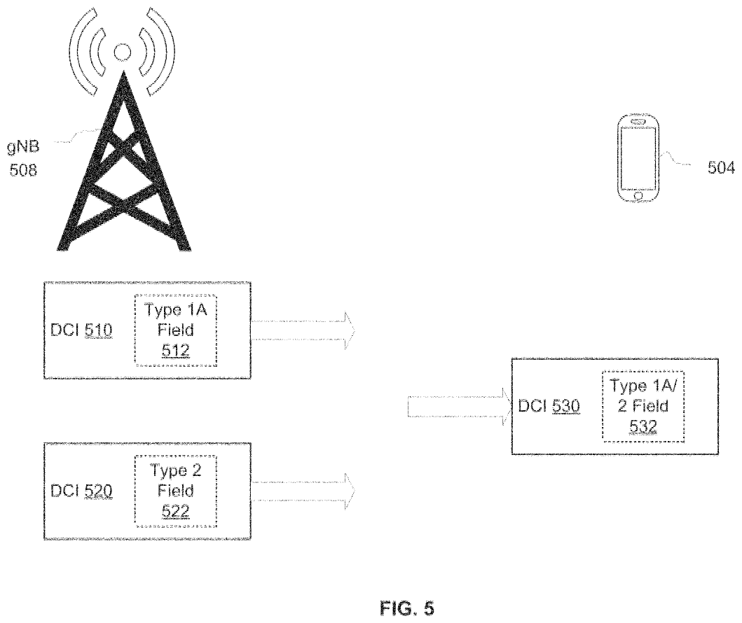

FIG. 5 illustrates an example of possible uses of different types of DCI fields for indicating DMRS antenna port numbers, in accordance with some embodiments. In an example, a gNB 508 (an example of gNB 108 of FIG. 1) configures multiple cells for a UE 504 (an example of the UE 104 of FIG. 1) and uses a single DCI (e.g., having a DCI format 0_X or 1_X) to co-schedule cells for the UE among the configured cells. This DCI also indicates, for each co-scheduled cell, a value for an index that the UE 504 uses to determine a set of DMRS antenna ports to use for the co-scheduled cell.

In one example, to avoid indicating a value for an index that cannot be used by the UE 504 to determine the set of DMRS antenna ports, the UE 504 is not expected to be configured with a type 1A field for port indication by single DCI format for multi-cell scheduling. In other words, if the size of the DMRS antenna port indication table for at least one of the co-scheduled cells is different than the size of the DMRS antenna port indication tables for the other co-scheduled cells and/or if the indicated index is reserved in the DMRS antenna port indication table for at least one of the co-scheduled cells, then the UE 504 is not expected to be configured with type 1A field for DMRS antenna port indication by single DCI format (for multi-cell scheduling). That can correspond to the UE 504 not expected to be configured with a single bitfield in the DCI format to indicate one/same index in each of the DMRS antenna port indication tables for each of the co-scheduled cells to determine the corresponding antenna port number(s) for transmission/reception of respective PDSCH/PUSCH.

In this case, the gNB 508 can initially configure the UE 504 (e.g., via RRC signaling) for using a type 2 field. Accordingly, the gNB 508 can send a DCI 520 to co-schedule the cells, but this DCI 520 does not include a type 1A field. Instead, the DCI 520 can include a type 2 field 522.

In another example, if a type 1A field is configured and a condition related to DMRS antenna port configuration is met (including any or all of the sub-conditions discussed herein above), the UE 504 can disregard the received type 1A field. In other words, if the size of the DMRS antenna port indication table for at least one of the co-scheduled cells is different than the size of the DMRS antenna port indication tables for the other co-scheduled cells and/or if the indicated index is reserved in the DMRS antenna port indication table for at least one of the co-scheduled cells, then the UE 504 can disregard a type 1A field for DMRS antenna port indication by single DCI format (for multi-cell scheduling). In this case, the gNB 508 can send a DCI 510 to co-schedule the cells and this DCI 510 includes a type 1A field. However, this DMRS antenna port indication field is interpreted by the UE 508 as a type 2A field.

In yet another example, the UE 504 can be configured for using both type 1A field and type 2 field. Prior to the scheduling, the gNB 508 can determine that a condition related to DMRS antenna port configuration is met (including any or all of the sub-conditions discussed herein above) for the to be co-scheduled cells. For example, the gNB 508 can determine the configuration of the cells and, given that particular ones are to be scheduled, can determine that the condition is met. In this case, the gNB 508 can send the DCI 520.

In a further example, the UE 504 can be configured for using both type 1A field and type 2 field. Here, upon receiving the single DCI indicating the co-scheduled cells, the UE 504 can determine that a condition related to DMRS antenna port configuration is met (including any or all of the sub-conditions discussed herein above). Because the condition is met, the UE 504 interprets the received DMRS antenna port indication field as a type 2 field. This is illustrated in FIG. 5 as following. If the gNB 508 sends the DCI 520, the UE 504 interprets the received DMRS antenna port indication field as a type 2 field. In FIG. 5, the transmitted DCI 520 is received as a DCI 530. The DMRS antenna port indication field in the DCI 530 is as a type 2 field and is interpreted as such. If the gNB 508 sends the DCI 510, the UE 504 interprets the received DMRS antenna port indication field also as a type 2 field. In FIG. 5, the transmitted DCI 510 is received as a DCI 530. The DMRS antenna port indication field in the DCI 530 is a type 1A field but is interpreted as a type 2 field. Conversely, if the condition is not met, the gNB 508 can send the DCI 510. In this case, the UE 504 interprets the received DMRS antenna port indication field also as a type 1A field. In FIG. 5, the transmitted DCI 510 is received as a DCI 530. The DMRS antenna port indication field in the DCI 530 is a type 1A field and is interpreted as such.

In an example, the UE 504 is configured with at least a type 1A field for DMRS antenna port indication by single DCI format (for multi-cell scheduling), such as when a single bitfield in the DCI format is used to indicate one index and the same index is used in each of the DMRS antenna port indication tables for each of the co-scheduled cells to determine the corresponding antenna port number(s) for transmission/reception of respective PDSCH/PUSCH. If the size of the DMRS antenna port indication table for at least one of the co-scheduled cells is different than the size of the DMRS antenna port indication tables for the other co-scheduled cells and/or if the indicated index is reserved in the DMRS antenna port indication table for at least one of the co-scheduled cells, then, the UE 504 can assume to be configured with a combination of Type 1A and Type 2 field type for DMRS antenna port indication by the single DCI format (for multi-cell scheduling). In other words, for the set of a co-scheduled cells that have the same size of the corresponding DMRS antenna port indication tables, a single bitfield is assumed for port indication. In comparison, for the at least one of the co-scheduled cells for which the size is different, additional DMRS antenna port indication field is used.

To illustrate, consider three cells: cell “0,” cell “1,” and cell “2.” If cell “0” and cell “1” have the same DMRS antenna port indication table size and cell “2” has a different size of the table, then a joint bitfield (code point in the DCI) is used for cell “0” and cell “1” (e.g., as a type 1A field) and an additional bitfield (code point in the DCI) is used for cell “2” (e.g., although configured as a type 1A field, it is interpreted as a type 2 field because it is separately used for cell “2” only).

In another illustration, consider four cells: cell “0,” cell “1,” cell “2,” and cell “3.” If cell “0” and cell “1” have the same first DMRS antenna port indication table size, cell “2” and cell “3” also have the same second DMRS antenna port indication table size table, and if the first and second DMR port indication table sizes are different, then a joint bitfield (code point in DCI) is used for cell “0” and cell “1” (e.g., as a first type 1A field) and an additional joint bitfield (code point in DCI) is used for cell “2” and cell “3” (e.g., as a second type 1A field), whereby the two joint bitfields collectively represent two type 2 fields (a first one for the group of cell “0” and cell “1,” and a second one for the group of cell “2” and cell “3”).

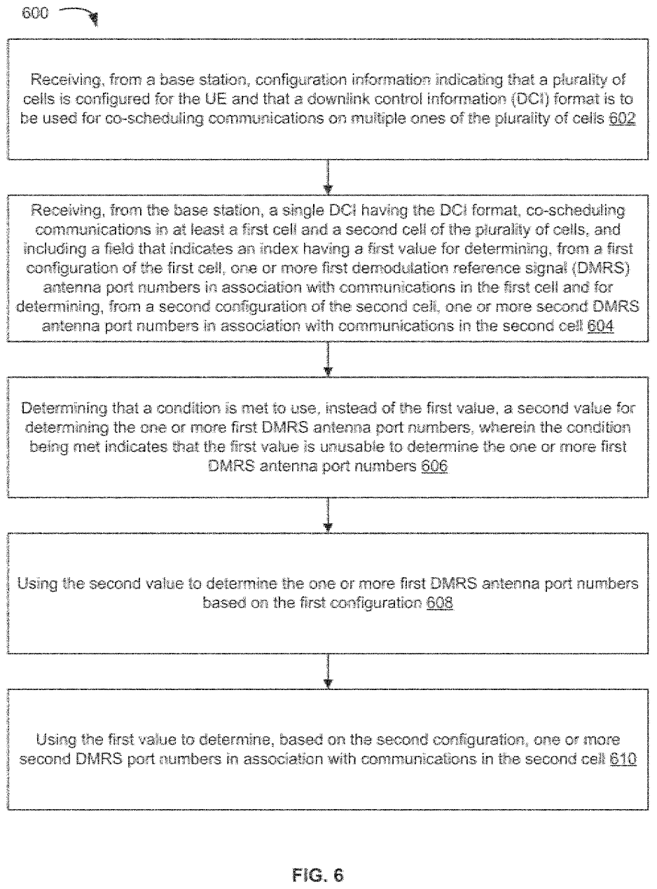

FIG. 6 illustrates an example of an operational flow/algorithmic structure 600 for a UE to determine DMRS antenna port numbers, in accordance with some embodiments. The UE is an example of any of the UEs described in the present disclosure. The operational flow/algorithmic structure 600 can be performed by the UE as a whole and/or by particular components thereof.

In an example, the operational flow/algorithmic structure 600 includes, at 602, receiving, from a base station, configuration information indicating that a plurality of cells is configured for the UE and that a downlink control information (DCI) format is to be used for co-scheduling communications on multiple ones of the plurality of cells. For example, the configuration information is received via RRC signaling, identifies the cells that are configured for use by the UE, includes DMRS antenna port indication tables for the cells, and indicates that DCI format 1_X and DCI format 0_X are to be used for co-scheduling cells among the configured cells and that such DCI formats would include a type 1A field.

In an example, the operational flow/algorithmic structure 600 includes, at 604, receiving, from the base station, a single DCI having the DCI format, co-scheduling communications in at least a first cell and a second cell of the plurality of cells, and including a field that indicates an index having a first value for determining, from a first configuration of the first cell, one or more first demodulation reference signal (DMRS) antenna port numbers in association with communications in the first cell and for determining, from a second configuration of the second cell, one or more second DMRS antenna port numbers in association with communications in the second cell. For example, the DCI has the DCI format 1_X or the DCI format 0_X with the type 1A field. The DCI can indicate the co-scheduled cells. The type 1A field can include a bitmap that indicates the first value. The first configuration can be a first DMRS antenna port indication table, whereas the second configuration can be a second DMRS antenna port indication table.

In an example, the operational flow/algorithmic structure 600 includes, at 606, determining that determining that a condition is met to use, instead of the first value, a second value for determining the one or more first DMRS antenna port numbers, wherein the condition being met indicates that the first value is unusable to determine the one or more first DMRS antenna port numbers. For example, the UE can determine that the first value is not present in a first DMRS antenna port indication table included in the first configuration and or that this table has a different size than a second DMRS antenna port indication table included in the second configuration. Or the UE can look up the first DMRS table antenna port table and determine that the first value is included but corresponds to a reserved value for the set of DMRS antenna ports.

In an example, the operational flow/algorithmic structure 600 includes, at 608, using the second value to determine the one or more first DMRS antenna port numbers based on the first configuration. For example, the UE can select the second value to be a default value such as being the value of the lowest index in the first DMRS antenna port indication table, the value of the highest index in the first DMRS antenna port indication table for which a non-reserved DMRS antenna port number(s) is (are) available, or a value configured to be between the lowest and highest indices. Accordingly, the UE uses the second value to look up the first DMRS antenna port indication table and determine a set of DMRS antenna port numbers for use. This determined set is used for receiving and processing DMRS from the base station using the first cell to then communicate with the base station using the first cell.

In an example, the operational flow/algorithmic structure 600 includes, at 610, using the first value to determine, based on the second configuration, one or more second DMRS antenna port numbers in association with communications in the second cell. In an example, the first value is usable for the second cell because, for this cell, the first value is present in the second DMRS antenna port indication table and corresponds to a non-reserved DMRS antenna port number(s) in the second DMRS antenna port indication table. Accordingly, the UE uses the first value to look up the second DMRS antenna port indication table and determine a set of DMRS antenna port numbers for use. This determined set is used for receiving and processing DMRS from the base station sent using the second cell to then communicate with the base station using the second cell.

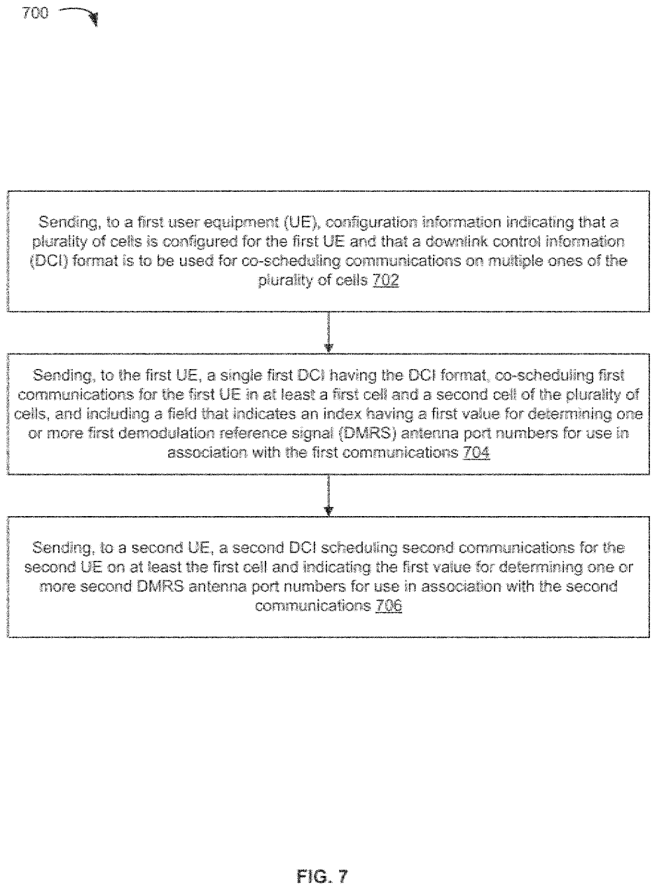

FIG. 7 illustrates an example of an operational flow/algorithmic structure 700 for a base station to indicate DMRS antenna port numbers, in accordance with some embodiments. The base station is an example of any of the base stations described in the present disclosure. The operational flow/algorithmic structure 700 can be performed by the base station as a whole and/or by particular components thereof.

In an example, the operational flow/algorithmic structure 700 includes, at 702, sending, to a first user equipment (UE), configuration information indicating that a plurality of cells is configured for the first UE and that a downlink control information (DCI) format is to be used for co-scheduling communications on multiple ones of the plurality of cells. For example, the configuration information is sent via RRC signaling, identifies the cells that are configured for use by the UE, includes DMRS antenna port indication tables for the cells, and indicates that DCI format 1_X and DCI format 0_X are to be used for co-scheduling cells among the configured cells and that such DCI formats would include a type 1A field.

In an example, the operational flow/algorithmic structure 700 includes, at 704, sending, to the first UE, a single first DCI having the DCI format, co-scheduling first communications for the first UE in at least a first cell and a second cell of the plurality of cells, and including a field that indicates an index having a first value for determining one or more first demodulation reference signal (DMRS) antenna port numbers for use in association with the first communications. For example, this DCI has the DCI format 1_X or the DCI format 0_X with the type 1A field. The DCI can indicate the co-scheduled cells. The type 1A field can include a bitmap that indicates the first value.

In an example, the operational flow/algorithmic structure 700 includes, at 706, sending, to a second UE, a second DCI scheduling second communications for the second UE on at least the first cell and indicating the first value for determining one or more second DMRS antenna port numbers for use in association with the second communications. For example, this DCI can be any usable format to schedule a PDSCH and/or PUSCH transmission and can include a field that indicates the first value. In an example, this second SCI can even be a DCI format 1_X or the DCI format 0_X with the type 1A field to indicate t co-scheduled cells for the second UE.

Indicating the same first value in the second DCI can be possible because, for example, the base station can determine that a condition is met for the first UE. This condition relates to DMRS antenna port indication tables of the first UE.

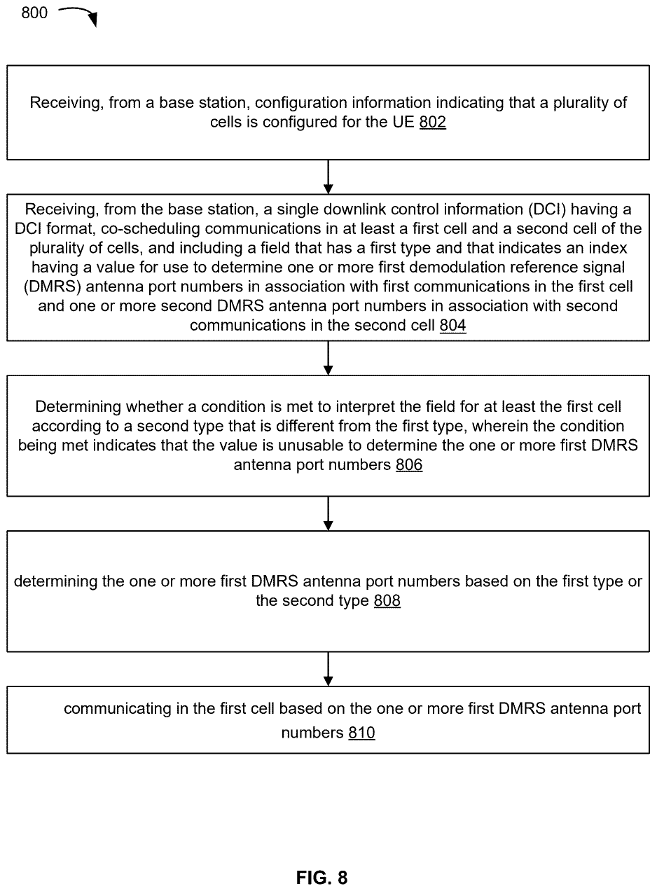

FIG. 8 illustrates another example of an operational flow/algorithmic structure 800 for a UE to determine DMRS antenna port numbers, in accordance with some embodiments. The UE is an example of any of the UEs described in the present disclosure. The operational flow/algorithmic structure 800 can be performed by the UE as a whole and/or by particular components thereof.

In an example, the operational flow/algorithmic structure 800 includes, at 802, receiving, from a base station, configuration information indicating that a plurality of cells is configured for the UE. For example, the configuration information is received via RRC signaling, identifies the cells that are configured for use by the UE, and includes DMRS antenna port indication tables for the cells.

In an example, the operational flow/algorithmic structure 800 includes, at 804, receiving, from the base station, a single downlink_control information (DCI) having a DCI format, co-scheduling communications in at least a first cell and a second cell of the plurality of cells, and including a field that has a first type and that indicates an index having a value for use to determine one or more first demodulation reference signal (DMRS) antenna port numbers in association with first communications in the first cell and one or more second DMRS antenna port numbers in association with second communications in the second cell. For example, the DCI has a DCI format 1_X or the DCI format 0_X with the type 1A field. The DCI can indicate the co-scheduled cells. The type 1A field can include a bitmap that indicates the value.

In an example, the operational flow/algorithmic structure 800 includes, at 806, determining whether a condition is met to interpret the field for at least the first cell according to a second type that is different from the first type, wherein the condition being met indicates that the value is unusable to determine the one or more first DMRS antenna port numbers. For example, the UE can determine that the value is not present in a first DMRS antenna port indication table included in the first configuration and or that this table has a different size than a second DMRS antenna port indication table included in the second configuration. Or the UE can look up the first DMRS table antenna port table and determine that the first value is included but corresponds to a reserved value for the set of DMRS antenna ports.

In an example, the operational flow/algorithmic structure 800 includes, at 808, determining the one or more first DMRS antenna port numbers based on the first type or the second type. For example, the first type (e.g., type 1A) is used if the condition is not met; otherwise, the second type (e.g., type 2) is used. The DCI is then interpreted according to the relevant type, as described herein above.

In an example, the operational flow/algorithmic structure 800 includes, at 810, communicating in the first cell based on the one or more first DMRS antenna port numbers. For example, the UE determines a set of DMRS antenna port numbers and uses this determined set for receiving and processing DMRS from the base station using the first cell to then communicate with the base station using the first cell.

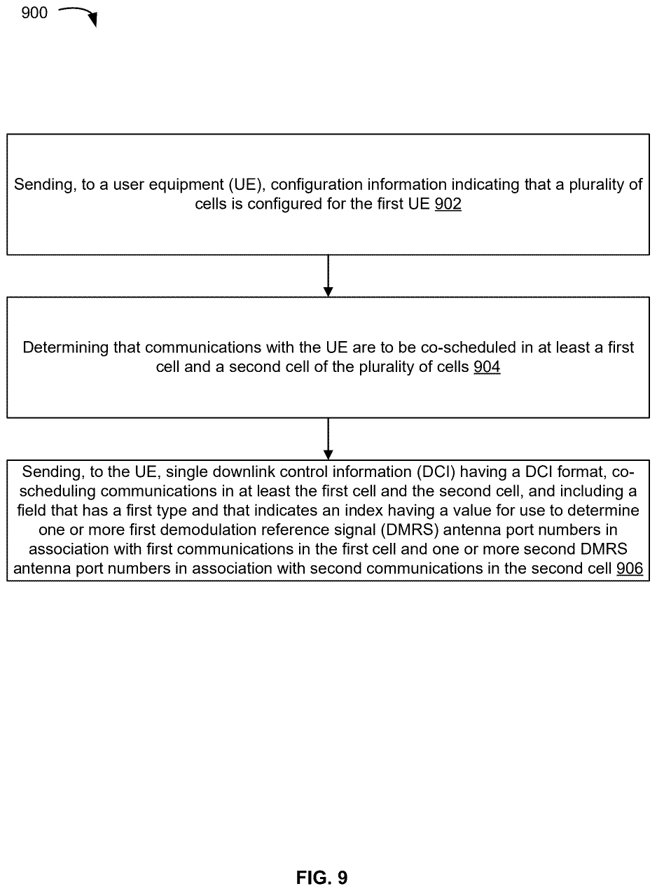

FIG. 9 illustrates another example of an operational flow/algorithmic structure 900 for a base station to indicate DMRS antenna port numbers, in accordance with some embodiments. The base station is an example of any of the base stations described in the present disclosure. The operational flow/algorithmic structure 900 can be performed by the base station as a whole and/or by particular components thereof.

In an example, the operational flow/algorithmic structure 900 includes, at 902, sending, to a user equipment (UE), configuration information indicating that a plurality of cells is configured for the UE. For example, the configuration information is sent via RRC signaling, identifies the cells that are configured for use by the UE, and includes DMRS antenna port indication table for the cells.

In an example, the operational flow/algorithmic structure 900 includes, at 904, determining that communications with the UE are to be co-scheduled in at least a first cell and a second cell of the plurality of cells. For example, this determination is based on data to be sent to the UE or based on a UE request for an uplink grant.

In an example, the operational flow/algorithmic structure 900 includes, at 906, sending, to the UE, a single downlink_control information (DCI) having a DCI format, co-scheduling communications in at least the first cell and the second cell, and including a field that has a first type and that indicates an index having a value for use to determine one or more first demodulation reference signal (DMRS) antenna port numbers in association with first communications in the first cell and one or more second DMRS antenna port numbers in association with second communications in the second cell. For example, prior to configuring the UE, the bae station determines that the DMRS antenna port indication tables and based on this table determines that a condition is met. Accordingly, as part of configuring the multiple cells for the UE, the base station can configure the use of type 2 fields, rather than type 1A fields in DCI formats 1_X and 0_X. In another example, the UE is configured to use both type 1A and type 2 fields. Prior to the scheduling of the cells, the base station can determine that a condition related to DMRS antenna port configuration is met for the to be co-scheduled cells. In this case, the base station sends a DCI that has the type 2 field. Or, if a DCI is sent having a type 1A field (e.g., in the case that only type 1A fields are configured), the base station can assume that the UE can interpret this field as a type 2 field.

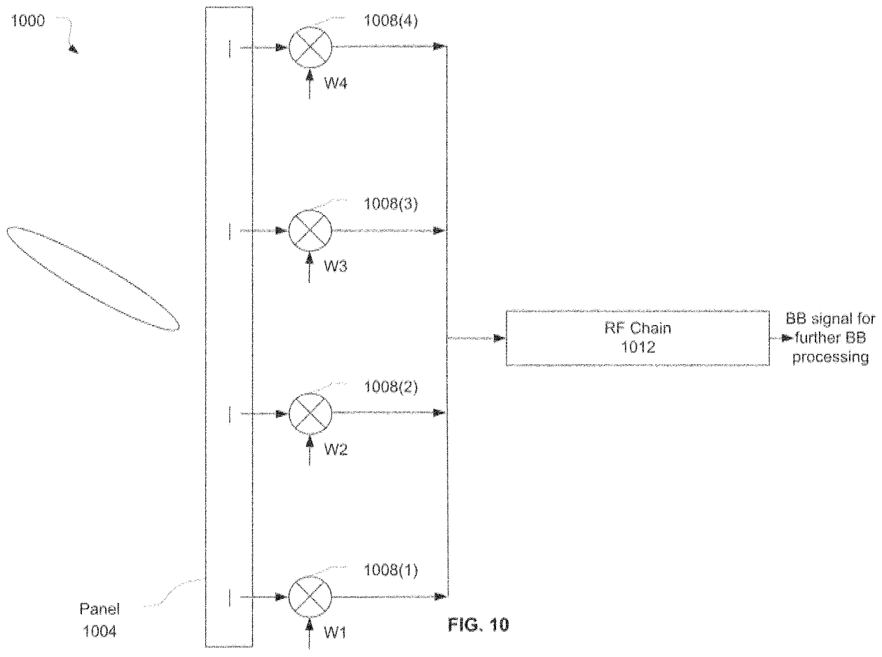

FIG. 10 illustrates receive components 1000 of the UE 104, in accordance with some embodiments. A device, such as one described in any of the above figures, can include similar receive components. The receive components 1000 may include an antenna panel 1004 that includes a number of antenna elements. The panel 1004 is shown with four antenna elements, but other embodiments may include other numbers.

The antenna panel 1004 may be coupled to analog beamforming (BF) components that include a number of phase shifters 1008(1)-1008(4). The phase shifters 1008(1)-1008(4) may be coupled with a radio-frequency (RF) chain 1012. The RF chain 1012 may amplify a receive analog RF signal, down-convert the RF signal to baseband, and convert the analog baseband signal to a digital baseband signal that may be provided to a baseband processor for further processing.

In various embodiments, control circuitry, which may reside in a baseband processor, may provide BF weights (for example W1-W4), which may represent phase shift values, to the phase shifters 1008(1)-1008(4) to provide a receive beam at the antenna panel 1004. These BF weights may be determined based on the channel-based beamforming.

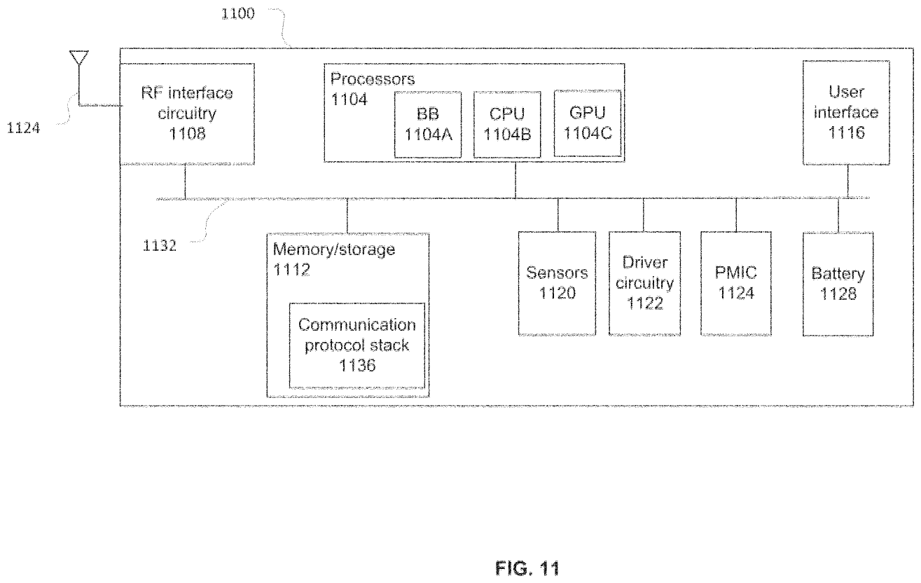

FIG. 11 illustrates a UE 1100 in accordance with some embodiments. The UE 1100 may be similar to and substantially interchangeable with UE 104 of FIG. 1.

Similar to that described above with respect to UE 104, the UE 1100 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, and actuators), video surveillance/monitoring devices (for example, cameras, and video cameras), wearable devices, or relaxed-IoT devices. In some embodiments, the UE may be a reduced capacity UE or NR-Light UE.

The UE 1100 may include processors 1104, RF interface circuitry 1108, memory/storage 1112, user interface 1116, sensors 1120, driver circuitry 1122, power management integrated circuit (PMIC) 1124, and battery 1128. The components of the UE 1100 may be implemented as integrated circuits (ICs), portions thereof, discrete electronic devices, or other modules, logic, hardware, software, firmware, or a combination thereof. The block diagram of FIG. 11 is intended to show a high-level view of some of the components of the UE 1100. However, some of the components shown may be omitted, additional components may be present, and different arrangements of the components shown may occur in other implementations.

The components of the UE 1100 may be coupled with various other components over one or more interconnects 1132 which may represent any type of interface, input/output, bus (local, system, or expansion), transmission line, trace, optical connection, etc. that allows various circuit components (on common or different chips or chipsets) to interact with one another.

The processors 1104 may include processor circuitry such as, for example, baseband processor circuitry (BB) 1104A, central processor unit circuitry (CPU) 1104B, and graphics processor unit circuitry (GPU) 1104C. The processors 1104 may include any type of circuitry or processor circuitry that executes or otherwise operates computer-executable instructions, such as program code, software modules, or functional processes from memory/storage 1112 to cause the UE 1100 to perform operations as described herein.

In some embodiments, the baseband processor circuitry 1104A may access a communication protocol stack 1136 in the memory/storage 1112 to communicate over a 3GPP compatible network. In general, the baseband processor circuitry 1104A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1108.

The baseband processor circuitry 1104A may generate or process baseband signals or waveforms that carry information in 3GPP-compatible networks. In some embodiments, the waveforms for NR may be based on cyclic prefix OFDM (CP-OFDM) in the uplink or downlink and discrete Fourier transform spread OFDM (DFT-S-OFDM) in the uplink.

The baseband processor circuitry 1104A may also access group information 1124 from memory/storage 1112 to determine search space groups in which a number of repetitions of a PDCCH may be transmitted.

The memory/storage 1112 may include any type of volatile or non-volatile memory that may be distributed throughout the UE 1100. In some embodiments, some of the memory/storage 1112 may be located on the processors 1104 themselves (for example, L1 and L2 cache), while other memory/storage 1112 is external to the processors 1104 but accessible thereto via a memory interface. The memory/storage 1112 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1108 may include transceiver circuitry and a radio frequency front module (RFEM) that allows the UE 1100 to communicate with other devices over a radio access network. The RF interface circuitry 1108 may include various elements arranged in transmit or receive paths. These elements may include switches, mixers, amplifiers, filters, synthesizer circuitry, control circuitry, etc.

In the receive path, the RFEM may receive a radiated signal from an air interface via an antenna 1124 and proceed to filter and amplify (with a low-noise amplifier) the signal. The signal may be provided to a receiver of the transceiver that down-converts the RF signal into a baseband signal that is provided to the baseband processor of the processors 1104.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1124.

In various embodiments, the RF interface circuitry 1108 may be configured to transmit/receive signals in a manner compatible with NR access technologies.

The antenna 1124 may include a number of antenna elements that each convert electrical signals into radio waves to travel through the air and to convert received radio waves into electrical signals. The antenna elements may be arranged into one or more antenna panels. The antenna 1124 may have antenna panels that are omnidirectional, directional, or a combination thereof to enable beamforming and multiple input, multiple output communications. The antenna 1124 may include micro-strip antennas, printed antennas that are fabricated on the surface of one or more printed circuit boards, patch antennas, phased array antennas, etc. The antenna 1124 may have one or more panels designed for specific frequency bands including bands in FR1 or FR2.

The user interface circuitry 1116 includes various input/output (I/O) devices designed to enable user interaction with the UE 1100. The user interface 11 16 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1100.

The sensors 1120 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lens-less apertures); light detection and ranging sensors; proximity sensors (for example, infrared radiation detector and the like); depth sensors; ambient light sensors; ultrasonic transceivers; microphones or other like audio capture devices; etc.

The driver circuitry 1122 may include software and hardware elements that operate to control particular devices that are embedded in the UE 1100, attached to the UE 1100, or otherwise communicatively coupled with the UE 1100. The driver circuitry 1122 may include individual drivers allowing other components to interact with or control various input/output (I/O) devices that may be present within or connected to the UE 1100. For example, driver circuitry 1122 may include a display driver to control and allow access to a display device, a touchscreen driver to control and allow access to a touchscreen interface, sensor drivers to obtain sensor readings of sensor circuitry 1120 and control and allow access to sensor circuitry 1120, drivers to obtain actuator positions of electro-mechanic components or control and allow access to the electro-mechanic components, a camera driver to control and allow access to an embedded image capture device, or audio drivers to control and allow access to one or more audio devices.

The PMIC 1124 may manage power provided to various components of the UE 1100. In particular, with respect to the processors 1104, the PMIC 1124 may control power-source selection, voltage scaling, battery charging, or DC-to-DC conversion.

In some embodiments, the PMIC 1124 may control, or otherwise be part of, various power saving mechanisms of the UE 1100. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1100 may power down for brief intervals of time and thus save power. If there is no data traffic activity for an extended period of time, then the UE 1100 may transition off to an RRC_Idle state, where it disconnects from the network and does not perform operations such as channel quality feedback, handover, etc. The UE 1100 goes into a very low power state and it performs paging where again it periodically wakes up to listen to the network and then powers down again. The UE 1100 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay, and it is assumed the delay is acceptable.

A battery 1128 may power the UE 1100, although in some examples the UE 1100 may be mounted deployed in a fixed location and may have a power supply coupled to an electrical grid. The battery 1128 may be a lithium-ion battery, a metal-air battery, such as a zinc-air battery, an aluminum-air battery, a lithium-air battery, and the like. In some implementations, such as in vehicle-based applications, the battery 1128 may be a typical lead-acid automotive battery.

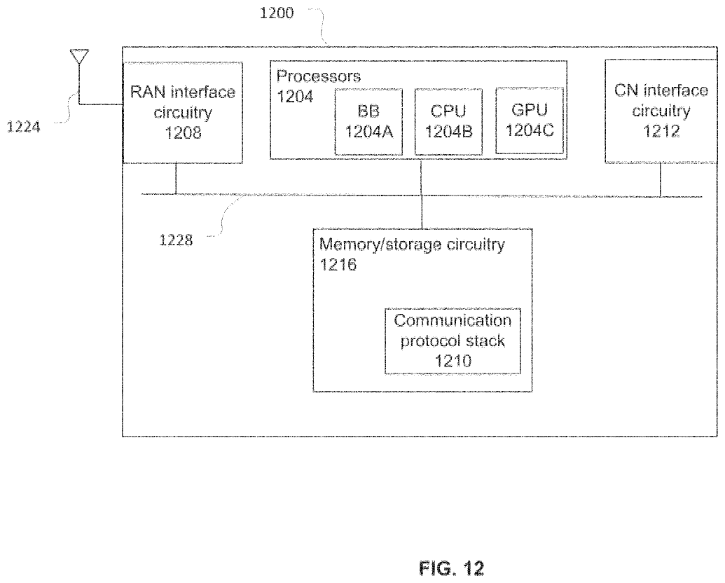

FIG. 12 illustrates a gNB 1200 in accordance with some embodiments. The gNB node 1200 may be similar to and substantially interchangeable with gNB 108. A base station can have the same or similar components as the gNB 1200.

The gNB 1200 may include processors 1204, RF interface circuitry 1208, core network (CN) interface circuitry 1212, and memory/storage circuitry 1216.

The components of the gNB 1200 may be coupled with various other components over one or more interconnects 1228.

The processors 1204, RF interface circuitry 1208, memory/storage circuitry 1216 (including communication protocol stack 1210), antenna 1224, and interconnects 1228 may be similar to like-named elements shown and described with respect to FIG. 10.

The CN interface circuitry 1212 may provide connectivity to a core network, for example, a 5^{th} Generation Core network (5GC) using a 5GC-compatible network interface protocol, such as carrier Ethernet protocols or some other suitable protocol. Network connectivity may be provided to/from the gNB 1200 via a fiber optic or wireless backhaul. The CN interface circuitry 1212 may include one or more dedicated processors or FPGAs to communicate using one or more of the aforementioned protocols. In some implementations, the CN interface circuitry 1212 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry, as described above in connection with one or more of the preceding figures, may be configured to operate in accordance with one or more of the examples set forth below. For another example, circuitry associated with a UE, base station, network element, etc., as described above in connection with one or more of the preceding figures, may be configured to operate in accordance with one or more of the examples set forth below in the example section.

### EXAMPLES

In the following sections, further exemplary embodiments are provided.

Example 1 includes a method implemented by a user equipment (UE), the method comprising: receiving, from a base station, configuration information indicating that a plurality of cells is configured for the UE and that a downlink control information (DCI) format is to be used for co-scheduling communications on multiple ones of the plurality of cells; receiving, from the base station, a single DCI having the DCI format, co-scheduling communications in at least a first cell and a second cell of the plurality of cells, and including a field that indicates an index having a first value for determining, from a first configuration of the first cell, one or more first demodulation reference signal (DMRS) antenna port numbers in association with communications in the first cell and for determining, from a second configuration of the second cell, one or more second DMRS antenna port numbers in association with communications in the second cell; determining that a condition is met to use, instead of the first value, a second value for determining the one or more first DMRS antenna port numbers, wherein the condition being met indicates that the first value is unusable to determine the one or more first DMRS antenna port numbers; using the second value to determine the one or more first DMRS antenna port numbers based on the first configuration; and using the first value to determine, based on the second configuration, one or more second DMRS antenna port numbers in association with communications in the second cell.

Example 2 includes a method implemented by a base station, the method comprising: sending, to a first user equipment (UE), configuration information indicating that a plurality of cells is configured for the first UE and that a downlink control information (DCI) format is to be used for co-scheduling communications on multiple ones of the plurality of cells; sending, to the first UE, a single first DCI having the DCI format, co-scheduling first communications for the first UE in at least a first cell and a second cell of the plurality of cells, and including a field that indicates an index having a first value for determining one or more first demodulation reference signal (DMRS) antenna port numbers for use in association with the first communications; and sending, to a second UE, a second DCI scheduling second communications for the second UE on at least the first cell and indicating the first value for determining one or more second DMRS antenna port numbers for use in association with the second communications.

Example 3 includes a method implemented by a user equipment (UE), the method comprising: receiving, from a base station, configuration information indicating that a plurality of cells is configured for the UE; receiving, from the base station, a single downlink control information (DCI) having a DCI format, co-scheduling communications in at least a first cell and a second cell of the plurality of cells, and including a field that has a first type and that indicates an index having a value for use to determine one or more first demodulation reference signal (DMRS) antenna port numbers in association with first communications in the first cell and one or more second DMRS antenna port numbers in association with second communications in the second cell; determining whether a condition is met to interpret the field for at least the first cell according to a second type that is different from the first type, wherein the condition being met indicates that the value is unusable to determine the one or more first DMRS antenna port numbers; determining the one or more first DMRS antenna port numbers based on the first type or the second type; and communicating in the first cell based on the one or more first DMRS antenna port numbers.

Example 4 includes a method implemented by a base station, the method comprising: sending, to a user equipment (UE), configuration information indicating that a plurality of cells is configured for the UE; determining that communications with the UE are to be co-scheduled in at least a first cell and a second cell of the plurality of cells; and sending, to the UE, a single downlink_control information (DCI) having a DCI format, co-scheduling communications in at least the first cell and the second cell, and including a field that has a first type and that indicates an index having a value for use to determine one or more first demodulation reference signal (DMRS) antenna port numbers in association with first communications in the first cell and one or more second DMRS antenna port numbers in association with second communications in the second cell.

Example 5 includes the method of any example 1-4, wherein the first configuration includes a first DMRS antenna port indication table, wherein the second configuration includes a second DMRS antenna port indication table, and wherein the condition includes at least one of: whether a size of the first DMRS antenna port indication table is different than that of the second DMRS antenna port indication table, or whether the first value corresponds to a reserved value in the first DMRS antenna port indication table.

Example 6 includes the method of example 5, wherein the second value is a default value set to be the lowest value or the highest value in the first DMRS antenna port indication table, the highest value not corresponding to the reserved value.

Example 7 includes the method of example 5, wherein the second value is pre-configured in the configuration information to be between the lowest value and the highest value in the first DMRS antenna port indication table.

Example 8 includes the method of example 5, wherein the condition further includes whether the first DMRS antenna port indication table is associated with a multi-symbol length DMRS.

Example 9 includes the method of example 8 further comprising: determining that the first DMRS antenna port indication table is associated with the multi-symbol length DMRS; and determining the second value to be the lowest value or the highest value for the multi-symbol length DMRS in the first DMRS antenna port indication table, the highest value not corresponding to the reserved value.

Example 10 includes the method of any example 1-9, wherein the single DCI has a DCI format 0_X or 1_X, and wherein the field is a type 1A field.

Example 11 includes the method of example 10, wherein the DCI format is at least one of DCI format 0_X or DCI format 1_X, and wherein the field is a type 1A field.

Example 12 includes the method of example 11, wherein the type 1A field indicates the first value to use in a first look-up by the first UE of a first DMRS antenna port indication table configured for the first cell and for a second look-up by the first UE of a DMRS antenna port indication table configured for the first cell.

Example 13 includes the method of example 12, wherein a result of the first look-up indicates that the first value is absent from the first DMRS antenna port indication table or corresponds to a reserved value in the first DMRS antenna port indication table.

Example 14 includes the method of example 13, wherein the result causes the first UE to use a second value from the first DMRS antenna port indication table to determine the one or more first DMRS antenna port numbers.

Example 15 includes the method of example 14, wherein the second value is the lowest value or the highest value in the first DMRS antenna port indication table, the highest value not corresponding to the reserved value.

Example 16 includes the method of example 14, wherein the first DMRS antenna port indication table is associated with a multiple symbol length DMRS, and wherein the second value is the lowest value or the highest value for the multiple symbol length DMRS in the first DMRS antenna port indication table.

Example 17 includes the method of any example 1-16, further comprising: determining, based on the configuration information, that a condition for co-scheduling the first cell and the second cell for the first UE is met; and including, in the second DCI sent to the second UE, the first value based on the condition being met for the first UE.

Example 18 includes the method of example 17, wherein the configuration information indicates a first DMRS antenna port indication table configured for the first cell and a second DMRS antenna port indication table configured for the second cell, and wherein the condition includes at least one of: whether a size of the first DMRS antenna port indication table is different than that of the second DMRS antenna port indication table, or whether the first value corresponds to a reserved value in the first DMRS antenna port indication table.

Example 19 includes the method of example 18, wherein the condition further includes whether the first DMRS antenna port indication table is associated with a multi-symbol length DMRS.

Example 20 includes the method of any example 1-19, wherein the configuration information further indicates that the DCI format is to be used for co-scheduling communications on multiple ones of the plurality of cells.

Example 21 includes the method of example 20, wherein the DCI format is at least one of DCI format 0_X or DCI format 1_X, wherein the first type is type 1A, and wherein the second type is type 2.

Example 22 includes the method of example 21, wherein the type 1A is used when the condition is not met, and wherein the type 2 is used when the condition is met.

Example 23 includes the method of any example 1-22, wherein the single DCI, the field, the index, and the value are a single first DCI, a first field, a first index, and a first value, respectively, and wherein the method further comprises: receiving, from the base station, a second single DCI having the DCI format, co-scheduling communications in at least the first cell and a third cell of the plurality of cells, and including a second field that has the first type and that indicates a second index having a second value for use to determine one or more third DMRS antenna port numbers in association with third communications in the third cell and one or more fourth DMRS antenna port numbers in association with fourth communications in the first cell; using the second value to determine, based on a third configuration for the third cell, one or more third DMRS antenna port numbers in association with third communications in the third cell; and using the second value to determine, based on a first configuration for the first cell, one or more fourth DMRS numbers in association with fourth communications in the first cell.

Example 24 includes the method of any example 1-26, wherein the configuration information indicates a first configuration for the first cell and a second configuration for the second cell, and wherein the condition is determined to be met is based on the first configuration and the second configuration.

Example 25 includes the method of example 24, wherein the first configuration includes a first DMRS antenna port indication table, wherein the second configuration includes a second DMRS antenna port indication table.

Example 26 includes the method of example 25, wherein the condition includes at least one of: whether a size of the first DMRS antenna port indication table is different than that of the second DMRS antenna port indication table, or whether the value corresponds to a reserved value in the first DMRS antenna port indication table.

Example 27 includes the method of any example 1-25, wherein the configuration information indicates a first DMRS antenna port indication table associated with the first cell and a second DMRS antenna port indication table associated with the second cell, and wherein the configuration information further indicates that DCI type 1A field and DCI type 2 field are configured for the UE in association with co-scheduling cells.

Example 28 includes the method of example 27, further comprising: determining, from the single DCI, that the first cell and the second cell are co-scheduled; determining that a size of the first DMRS antenna port indication table is the same as that of the second DMRS antenna port indication table; determining that a single bitfield is indicated in the field; and using the single bitfield to determine the one or more first DMRS antenna port numbers and the one or more second DMRS antenna port numbers.

Example 29 includes the method of example 27, further comprising: determining, from the single DCI, that the first cell and the second cell are co-scheduled; determining that a size of the first DMRS antenna port indication table is different than that of the second DMRS antenna port indication table; determining that the field is a first field usable to determine the one or more first DMRS antenna port numbers field and that a second field in the DCI is usable to determine the one or more second DMRS antenna port numbers; using the first field to determine the one or more first DMRS antenna port numbers; and using the second field to determine the one or more second DMRS antenna port numbers.

Example 30 includes the method of any example 1-29, wherein the DCI format is at least one of DCI format 0_X or DCI format 1_X, wherein the first type is type 1A, wherein the single DCI causes the UE to interpret the field according to a second type that is type 2 based on a condition being met.

Example 31 includes the method of example 30, wherein the configuration information indicates a first DMRS antenna port indication table associated with the first cell and a second DMRS antenna port indication table associated with the second cell, and wherein the condition includes at least one of: whether a size of the first DMRS antenna port indication table is different than that of the second DMRS antenna port indication table, or whether the value corresponds to a reserved value in the first DMRS antenna port indication table.

Example 32 includes the method of any example 1-31, further comprising: determining that a condition associated with co-scheduling the first cell and the second cell is met for the UE, wherein the field is a type 2 field based on the condition being met.

Example 33 includes the method of example 32, wherein the condition includes at least one of: whether a size of the first DMRS antenna port indication table associated with the first cell is different than that of the second DMRS antenna port indication table associated with the second cell, or whether the value corresponds to a reserved value in the first DMRS antenna port indication table.

Example 34 includes the method of any example 1-34, wherein the DCI format is at least one of DCI format 0_X or DCI format 1_X, and wherein the method further comprises: determining that using a type 1A for the type is unsuitable for at least the first communications; and using a type 2 for the type instead of the type 1A.

Example 35 includes the method of example 34, wherein the type 1A is unsuitable based on a condition being met, wherein the condition includes at least one of: whether a size of a first DMRS antenna port indication table associated with the first cell is different than that of a second DMRS antenna port indication table associated with the second cell, or whether the value corresponds to a reserved value in the first DMRS antenna port indication table.

Example 36 includes the method of any example 1-35, wherein the UE and the single DCI are a first UE and a single first DCI, respectively, and wherein the method further comprises: sending, to a second UE, a second DCI scheduling third communications for the second UE in at least the first cell and indicating the value for determining one or more DMRS antenna port numbers for use in association with the third communications.

Example 37 includes the method of example 36, further comprising: determining, based on the configuration information, that a condition for co-scheduling the first cell and the second cell for the first UE is met; and including, in the second DCI sent to the second UE, the value based on the condition being met for the first UE.

Example 38 includes the method of example 37, wherein the condition includes whether a size of a first DMRS antenna port indication table associated with the first cell is different than that of a second DMRS antenna port indication table associated with the second cell.

Example 39 includes the method of example 38, wherein the condition further includes whether the value corresponds to a reserved value in the first DMRS antenna port indication table.

Example 40 includes a device comprising means to perform one or more elements of a method described in or related to any of the examples 1-39.

Example 41 includes one or more non-transitory computer-readable media comprising instructions to cause a device, upon execution of the instructions by one or more processors of the device, to perform one or more elements of a method described in or related to any of the examples 1-39.

Example 42 includes a device comprising logic, modules, or circuitry to perform one or more elements of a method described in or related to any of the examples 1-39.

Example 43 includes a device comprising: one or more processors and one or more computer-readable media comprising instructions that, when executed by the one or more processors, cause the one or more processors to perform one or more elements of a method described in or related to any of the examples 1-39.

Example 44 includes a system comprising means to perform one or more elements of a method described in or related to any of the examples 1-39.

Example 45 includes a network comprising means to perform one or more elements of a method described in or related to any of the examples 1-39.

Example 46 includes one or more non-transitory computer-readable media comprising instructions to cause a network, upon execution of the instructions by one or more processors of the network, to perform one or more elements of a method described in or related to any of the examples 1-39.

Example 47 includes a network comprising logic, modules, or circuitry to perform one or more elements of a method described in or related to any of the examples 1-39.

Example 48 includes a network comprising: one or more processors and one or more computer-readable media comprising instructions that, when executed by the one or more processors, cause the one or more processors to perform one or more elements of a method described in or related to any of the examples 1-39.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations, and modifications will become apparent to those skilled in the art once the above disclosure is fully appreciated. It is intended that the following claims be interpreted to embrace all such variations and modifications.

1.-20. (canceled)

21. A method comprising:
processing configuration information received from a base station and indicating that a plurality of cells is configured for a user equipment (UE) and that a downlink control information (DCI) format is to be used for co-scheduling communications on multiple ones of the plurality of cells;
processing single DCI received from the base station, having the DCI format, co-scheduling communications in at least a first cell and a second cell of the plurality of cells, and including a field that indicates an index having a first value for determining, from a first configuration of the first cell, at least one first demodulation reference signal (DMRS) antenna port numbers in association with communications in the first cell and for determining, from a second configuration of the second cell, at least one second DMRS antenna port numbers in association with communications in the second cell;
determining that a condition is met to use, instead of the first value, a second value for determining the at least one first DMRS antenna port numbers, wherein the condition being met indicates that the first value is unusable to determine the at least one first DMRS antenna port numbers;
using the second value to determine the at least one first DMRS antenna port numbers based on the first configuration; and
using the first value to determine, based on the second configuration, at least one second DMRS antenna port numbers in association with communications in the second cell.

22. The method of claim 21, wherein the first configuration includes a first DMRS antenna port indication table, wherein the second configuration includes a second DMRS antenna port indication table, and wherein the condition includes at least one of: whether a size of the first DMRS antenna port indication table is different than that of the second DMRS antenna port indication table, or whether the first value corresponds to a reserved value in the first DMRS antenna port indication table.

23. The method of claim 22, wherein the second value is a default value set to be the lowest value or the highest value in the first DMRS antenna port indication table, the highest value not corresponding to the reserved value.

24. The method of claim 22, wherein the second value is pre-configured in the configuration information to be between the lowest value and the highest value in the first DMRS antenna port indication table.

25. The method of claim 22, wherein the condition further includes whether the first DMRS antenna port indication table is associated with a multi-symbol length DMRS.

26. The method of claim 25 further comprising:
determining that the first DMRS antenna port indication table is associated with the multi-symbol length DMRS; and
determining the second value to be the lowest value or the highest value for the multi-symbol length DMRS in the first DMRS antenna port indication table, the highest value not corresponding to the reserved value.

27. The method of claim 21, wherein the single DCI has a DCI format 0_X or 1_X, and wherein the field is a type 1A field.

28. A method comprising:
generating, for transmission to a first user equipment (UE), configuration information indicating that a plurality of cells is configured for the first UE and that a downlink control information (DCI) format is to be used for co-scheduling communications on multiple ones of the plurality of cells;
generating, for transmission to the first UE, single first DCI having the DCI format, co-scheduling first communications for the first UE in at least a first cell and a second cell of the plurality of cells, and including a field that indicates an index having a first value for determining at least one first demodulation reference signal (DMRS) antenna port numbers for use in association with the first communications; and
generating, for transmission to a second UE, second DCI scheduling second communications for the second UE on at least the first cell and indicating the first value for determining at least one second DMRS antenna port numbers for use in association with the second communications.

29. The method of claim 28, wherein the DCI format is at least one of DCI format 0_X or DCI format 1_X, and wherein the field is a type 1A field.

30. The method of claim 29, wherein the type 1A field indicates the first value to use in a first look-up by the first UE of a first DMRS antenna port indication table configured for the first cell and for a second look-up by the first UE of a DMRS antenna port indication table configured for the first cell.

31. The method of claim 30, wherein a result of the first look-up indicates that the first value is absent from the first DMRS antenna port indication table or corresponds to a reserved value in the first DMRS antenna port indication table.

32. The method of claim 31, wherein the result causes the first UE to use a second value from the first DMRS antenna port indication table to determine the at least one first DMRS antenna port numbers.

33. The method of claim 32, wherein the second value is the lowest value or the highest value in the first DMRS antenna port indication table, the highest value not corresponding to the reserved value.

34. The method of claim 32, wherein the first DMRS antenna port indication table is associated with a multiple symbol length DMRS, and wherein the second value is the lowest value or the highest value for the multiple symbol length DMRS in the first DMRS antenna port indication table.

35. The method of claim 28 further comprising:
determining, based on the configuration information, that a condition for co-scheduling the first cell and the second cell for the first UE is met; and
including, in the second DCI sent to the second UE, the first value based on the condition being met for the first UE.

36. The method of claim 35, wherein the configuration information indicates a first DMRS antenna port indication table configured for the first cell and a second DMRS antenna port indication table configured for the second cell, and wherein the condition includes at least one of: whether a size of the first DMRS antenna port indication table is different than that of the second DMRS antenna port indication table, or whether the first value corresponds to a reserved value in the first DMRS antenna port indication table.

37. The method of claim 36, wherein the condition further includes whether the first DMRS antenna port indication table is associated with a multi-symbol length DMRS.

38. An apparatus comprising:
processing circuitry configured to:
process configuration information received from a base station and indicating that a plurality of cells is configured for a user equipment (UE) and that a downlink control information (DCI) format is to be used for co-scheduling communications on multiple ones of the plurality of cells;
process single DCI received from the base station, having the DCI format, co-scheduling communications in at least a first cell and a second cell of the plurality of cells, and including a field that indicates an index having a first value for determining, from a first configuration of the first cell, at least one first demodulation reference signal (DMRS) antenna port numbers in association with communications in the first cell and for determining, from a second configuration of the second cell, at least one second DMRS antenna port numbers in association with communications in the second cell;
determine that a condition is met to use, instead of the first value, a second value for determining the at least one first DMRS antenna port numbers, wherein the condition being met indicates that the first value is unusable to determine the at least one first DMRS antenna port numbers;
use the second value to determine the at least one first DMRS antenna port numbers based on the first configuration; and
use the first value to determine, based on the second configuration, at least one second DMRS antenna port numbers in association with communications in the second cell.

39. The apparatus of claim 38, wherein the first configuration includes a first DMRS antenna port indication table, wherein the second configuration includes a second DMRS antenna port indication table, and wherein the condition includes at least one of: whether a size of the first DMRS antenna port indication table is different than that of the second DMRS antenna port indication table, or whether the first value corresponds to a reserved value in the first DMRS antenna port indication table.

40. The apparatus of claim 39, wherein the second value is a default value set to be the lowest value or the highest value in the first DMRS antenna port indication table, the highest value not corresponding to the reserved value.
